(19) United States
(12) Patent Application Publication
(10) Pub. No.: US 2001/0032057 A1
(43) Pub. Date: Oct. 18, 2001

(54) Initial calibration of a location sensing whiteboard to a projected display

(76) Inventors: Randall G. Smith, Marblehead, MA (US); Timothy J. Martell, Lexington, MA (US)

Correspondence Address: TROUTMAN SANDERS LLP, BANK OF AMERICA PLAZA, SUITE 5200, 600 PEACHTREE STREET , NE, ATLANTA, GA, 30308-2216, US

(21) Appl. No.: 09/746,754

(22) Filed: Dec. 21, 2000

Related U.S. Application Data
(60) Provisional application No. 60/172,029, filed on Dec. 23, 1999.

(51) Int. Cl. G01C 17/38

(52) U.S. Cl. 702/94

(57) ABSTRACT

The present invention is a method and system for initial calibration of a location sensing electronic whiteboard. The electronic whiteboard is connected to a personal computer, which is coupled to a computer projector for projecting an image onto the surface of the electronic whiteboard. In the exemplary embodiment, the surface of the electronic whiteboard contains a calibration icon. Once the user touches the calibration icon on the electronic whiteboard surface, a dialog box appears in the projected image containing one or more calibration point, which in the exemplary embodiment, are located at the intersection of two red lines. Once a touches are detected on the surface of the electronic whiteboard, the location of the detected touch is used as the calibration points to relate positions on the whiteboard to positions on the display of the computer.

### PRIORITY

This application claims priority to U.S. application Ser. No. 0/172,029 filed on Dec. 23, 1999 entitled Initial Calibration of a Location Sensing Whiteboard to a Projected Display.

### BACKGROUND OF THE INVENTION

1. Field of the Invention

This invention relates generally to the field of calibrating display devices, and more particularly to a method and system for calibrating positions on the surface of a location sensing whiteboard to positions on a projected display.

2. Description of Related Art

An electronic whiteboard is a familiar dry erase whiteboard, primarily used for meetings and presentations, that saves everything written on its surface to a computer connected to or embedded in the whiteboard. In the prior art forms, the user writes on the electronic whiteboard surface using dry erase markers, while in others, the user uses a non-marking stylus. The manner of writing on both forms will be referred to collectively as “writes” or “writing.” Regardless of the type of instrument used to write on the surface, the electronic whiteboard saves all the information written on its surface in electronic format to a PC via a software program. The user can then print, fax, e-mail, and edit the meeting notes that were written on the whiteboard surface. Just as electronic whiteboards can detect writing on the whiteboard surface, electronic whiteboards also can sense the location of a touch on the whiteboard surface.

Electronic whiteboards provide many benefits to users during meetings and presentations. By saving the notes written on the whiteboard to a computer so that the notes can be printed out or emailed to others, the whiteboard provides an accurate record of the meeting or presentation. This feature of whiteboards allows everyone present to focus on the meeting, not on note taking. Also, because the electronic whiteboard can sense the location of a touch, the computer can be controlled by touching buttons belonging to the graphical user interface in the projected display. This allows the user to control the flow of the meeting without leaving the front of the room.

Electronic whiteboards, however, do have their disadvantages. Usually, they are complicated to use. This disadvantage prevents novice users from enjoying the benefits such technology offers for meetings and presentations. One of the complications present in using electronic whiteboards is the calibration of the whiteboard. Calibration is necessary so that the computer can properly relate positions on the whiteboard to locations on the computer display device, and thus, properly interpret touch inputs detected on the surface of the electronic whiteboard. Typically, calibrating the electronic whiteboard involves the user operating at the computer, rather than at the electronic whiteboard, to start a calibration. Then, after the user initiates the initial calibration at the computer, the user must perform a calibration of the electronic whiteboard. This complicated procedure, usually calling for the assistance of another person, scares novice technology users away from electronic whiteboard technology, and overcomplicates the set-up process for those who do use electronic whiteboards.

Therefore, it can be seen that there is a need in the art for an improved calibration method for whiteboards that overcomes these and other prior art deficiencies.

### BRIEF SUMMARY OF THE INVENTION

Briefly described, in a preferred form, the present invention is “one-touch” initial calibration process and system for a location sensing electronic whiteboard. The calibration method and system of the present invention overcomes the complications posed by the prior art by providing an easy and simple way to calibrate an electronic whiteboard. A mechanism on the electronic whiteboard signals the computer to begin the calibration procedure before the computer has projected a GUI (graphical user interface) onto the electronic whiteboard surface. In the exemplary embodiment, this GUI is a predefined location on the whiteboard surface functioning as a calibration button or icon. However, the predefined location may be anywhere on either the whiteboard surface, or may also possibly be an actual or physical button on the whiteboard surface or whiteboard frame, as opposed to a logical button. Once a touch is detected at the predefined location for the calibration button, the computer begins the calibration sequence. The calibration sequence is an operation that through some set of points, determined to coincide between a projected computer image and coordinates from a physical projection surface, establishes a mathematical relationship to convert any point on the physical projection surface to a specific location on the displayed computer image. If the computer is not projecting an image onto the whiteboard surface, i.e., operating in projection mode, then the user must first enter projection mode before calibration in the exemplary embodiment. The present invention makes electronic whiteboards increasingly easier to operate and more attractive to novice computer and technology users by simplifying the calibration process to the simple touch of a button.

Accordingly, it is an object of the present invention to provide an improved and simple method and system for calibrating a location sensitive surface, which is an electronic whiteboard in the exemplary embodiment. These and other objects, features and advantages of the present invention will become more apparent upon reading the following specification in conjunction with the accompanying drawing figures.

### BRIEF DESCRIPTION OF THE FIGURES

FIG. 1 is a simplified system diagram illustrating an exemplary environment of the present invention.

FIG. 2 is a flow diagram illustrating the calibration method of the present invention when the computer and electronic whiteboard are not in projection mode.

FIG. 3 is a flow diagram illustrating the calibration method of the present invention when the computer and electronic whiteboard are in projection mode.

### DETAILED DESCRIPTION OF A PREFERRED EMBODIMENT

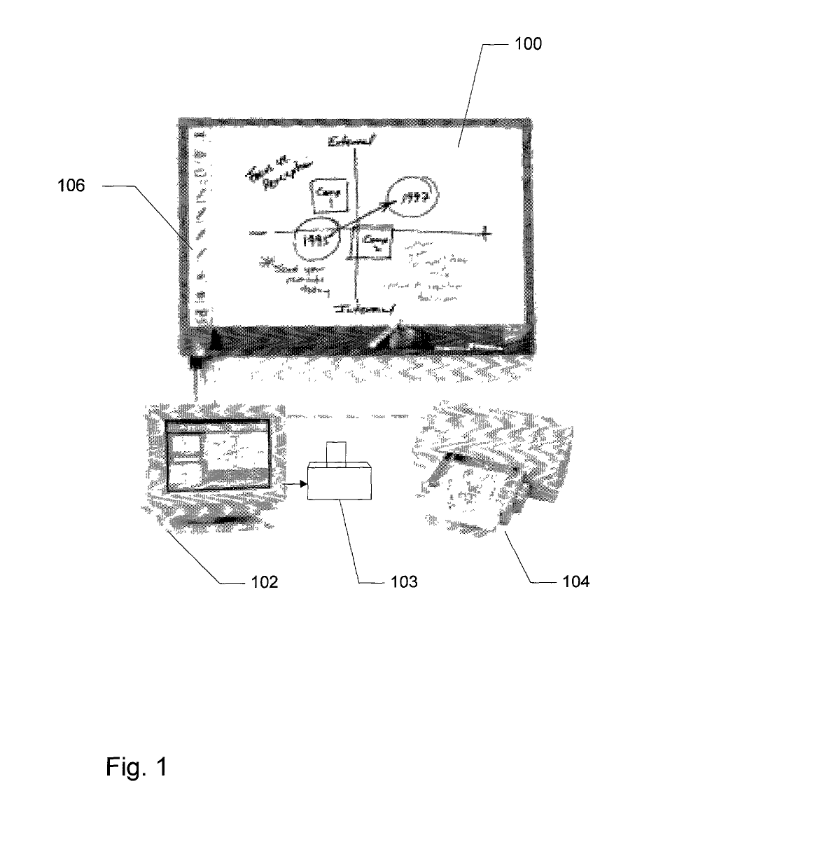

Referring to the drawings of the present application, FIG. 1 is provided as a simplified system diagram illustrating an exemplary environment of the present invention. Although the exemplary environment is shown as embodied within a personal computer and an electronic whiteboard, those skilled in the art will appreciate that the present invention may be embodied in any display arrangement involving a location sensitive surface and a projection of a computer generated image on the location sensitive surface requiring calibration.

In the exemplary embodiment, the electronic whiteboard 100 is calibrated via the method of present invention. Electronic whiteboards 100, acceptable in accordance with the exemplary embodiment, include products from vendors such as MIMIO, eBEAM, and IBID, among others. Electronic whiteboard 100 could also include, but is not limited to, any laser-triangulation touch resistive or capacitive film, radio sensitive surface, or ultrasonic frequency sensitive device. As shown in these figures, electronic whiteboard 100 is connected to personal computer 102. This connection can be via a wired connection, via but not limited to, a metallic or fiberoptic wired connection, a wireless connection via a wireless data transferring protocol, or via a network connecting electronic whiteboard 100, personal computer 102, and any peripheral devices 104. In the exemplary embodiment, system requirements for personal computer 102 to operate the present invention include the capability to output video data to a projection device, and software requirements include software to convert electronic whiteboard coordinates to screen coordinates, such as the Ibid Software. In the exemplary environment for the present invention, peripheral device 104 is a printer is connected to the computer 102 which may be used to print the images detected on electronic whiteboard 100.

As described, the electronic whiteboard 100 comprises a location sensitive surface. Examples of location sensitive surfaces include but are not limited to the above mentioned camera based systems, including also but not limited to, laser beam detection methods and infrared positioning devices. A computer projector 103, available from INFOCUS SYSTEMS, 3M, and TOSHIBA among others, is connected to personal computer 102. The physical surface of the electronic whiteboard 100 includes a menu bar 106, which in the exemplary embodiment, includes a calibration button which is the predefined location for beginning the calibration sequence once touch is detected. However, those skilled in the art will appreciate that the predefined location may be not only a logical calibration button on a menu bar 106, but any predefined location or command which may be programmed to begin the calibration sequence, such as an actual physical button located on the frame of the whiteboard, on the whiteboard surface, or remotely from the whiteboard frame or surface. Alternatively, the calibration sequence may also be initiated by a detected voice command.

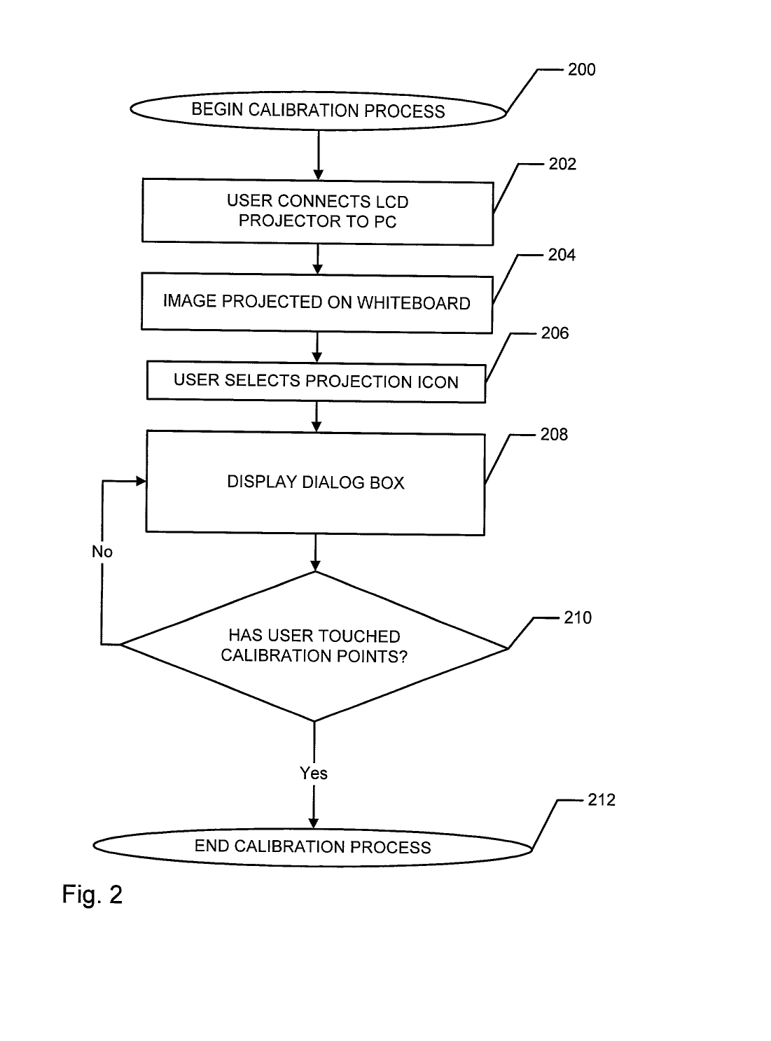

FIG. 2 is a flow diagram illustrating the calibration method of the present invention when the computer and electronic whiteboard are not in projection mode. The computer and the electronic whiteboard are not in projection mode if the computer is not projecting an image via the projector onto the touch sensitive surface of the electronic whiteboard. In this situation, to begin the calibration process 200, the user must connect the projector to the personal computer 202. In the exemplary embodiment, the projector is an external device, but the projector may also be located internally to personal computer 102. Furthermore, the connection between the projector and to the personal computer may be either a wired or wireless connection.

Once the projector is properly connected to the personal computer, an image must be projected onto the whiteboard to begin the calibration process 204. Once the image is projected on the electronic whiteboard 204, then the user selects the projection icon located on the physical menu bar to commence calibration 206. A dialog box 208 is then projected onto the electronic whiteboard surface. The dialog box instructs the user to touch the screen at one or more calibration points. These calibration points may be ascertained by requesting the user touch the surface of the electronic whiteboard at the intersection of two lines which are projected onto the electronic whiteboard surface, by requesting the user touch the surface of the electronic whiteboard in four points in each corner, or any other manner which can establish the user touching the surface of the electronic whiteboard at one or more calibration points. Until the user has touched the surface of the electronic whiteboard at the calibration points 210, the dialog box remains instructing the user to do so. Once the touch location sensitive surface of the electronic whiteboard detects that the user has touched the one or more calibration points 210, these locations are used for relating locations on the electronic whiteboard display to positions on the display of the computer, thus allowing the computer to calculate generally the relationship between a touch on the whiteboard and a position on the display.

This relationship between the calibration point and the position on the display of the computer can be calculated using the various calibration calculations techniques which are known to those skilled in the art. In the exemplary embodiment, the relationship between the locations on the electronic whiteboard display to positions on the display of the computer are calculated by first establishing a variable number of constants, which is nine in the exemplary embodiment. These constants are then used to form a matrix of values mapping each location on the surface of the electronic whiteboard to a position in the display of the computer. This provides a matrix which is used each time the user writes or touches the screen on the electronic whiteboard for determining the appropriate location for placing the cursor on the computer display. Once the touch is detected at the one or more calibration points, and this relationship is calculated, the calibration process concludes 212.

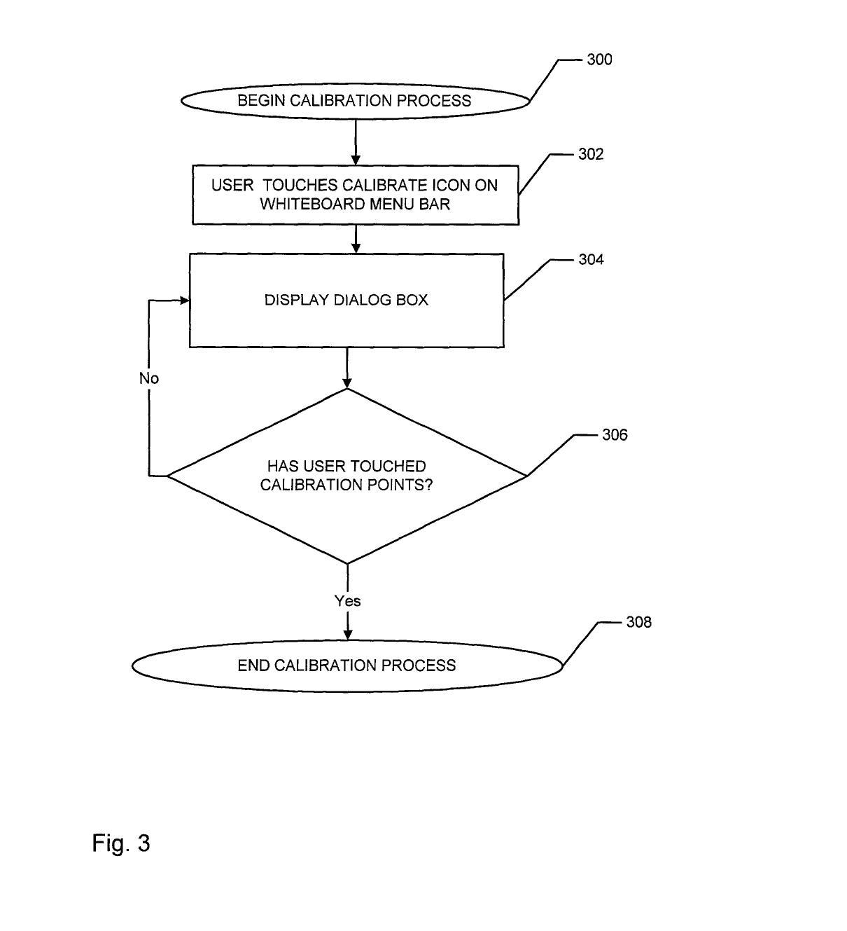

FIG. 3 is a flow diagram illustrating the calibration method of the present invention when the computer and electronic whiteboard are in projection mode. Because the computer is already projecting an image onto the surface of the electronic whiteboard in projection mode, to begin the calibration process 300, the user simply touches the calibrate icon on the physical menu bar on the surface of the electronic whiteboard 302. In the exemplary embodiment, the above described calibration process is initiated by the user touching the calibrate icon on the physical menu bar on the electronic whiteboard surface 302. However, those skilled in the art will appreciate that the present invention may also operate with an actual button the surface of the electronic whiteboard, an actual button on the frame of the electronic whiteboard, a remote programmed to initiate initial calibration, or any other operation, key sequence, or command which may initiate initial calibration.

Once the user selects the calibrate icon on the physical menu bar on the surface of the electronic whiteboard, a dialog box is displayed on the surface of the electronic whiteboard instructing the user to touch the surface of the electronic whiteboard at one or more calibration points. These instructions may request that the user touch the point at which the two lines intersect, that the user touch points located in the four comers of the electronic whiteboard surface, or any other manner which can establish the user touching the surface of the electronic whiteboard at a calibration point. If a touch has yet to be detected on the surface of the electronic whiteboard 306 at the one or more calibration points, then the dialog box remains instructing the user to touch the one or more calibration points on the electronic whiteboard surface 304. Once the user has touched the calibration points 306, then the computer uses the locations where the touch was detected to relate each location to a certain positions on the computer display corresponding to that location as described above. This completes the calibration process 308.

Terms used in describing the embodiments shown and the drawings are merely for purposes of description and do not necessarily apply to the position or manner in which the invention may be constructed for use. Furthermore, while the invention has been disclosed in its preferred forms, it will be apparent to those skilled in the art that many modifications, additions, and deletions can be made therein without departing from the spirit and scope of the invention and its equivalents as set forth in the following claims.

What is claimed is:

1. A method of calibrating positions between a location sensing electronic device and an electronic device coupled to a display device, comprising the steps of:
projecting an image onto a surface of a location sensing electronic device;
detecting a touch at a predefined calibration point on the surface of the location sensing electronic device; and
calculating a relationship between the predefined calibration point on the surface of the location sensing electronic device and a position on the display device.

2. The method of claim 1, wherein detecting a touch at a predefined calibration point comprises detecting selection of an actual button the surface of the location sensing electronic device.

3. The method of claim 1, wherein detecting a touch at a predefined calibration point comprises detecting selection of an actual button on an exterior frame of the location sensing electronic device.

4. The method of claim 1, wherein detecting a touch at a predefined calibration point comprises detecting selection of an projected button on the surface of the location sensing electronic device.

5. A method of calibrating positions between the surface of a location sensing electronic whiteboard and the display of a personal computer, comprising the steps of:
projecting an image onto a surface of a location sensing electronic whiteboard;
detecting a touch at a predefined calibration point on the surface of the location sensing electronic whiteboard; and
calculating a relationship between the predefined calibration point on the location sensing electronic whiteboard and a position on the display of the personal computer.

6. The method of claim 5, wherein detecting a touch at a predefined calibration point comprises detecting selection of an actual button the surface of the location sensing electronic whiteboard.

7. The method of claim 5, wherein detecting a touch at a predefined calibration point comprises detecting selection of an actual button on an exterior frame of the location sensing electronic whiteboard.

8. The method of claim 5, wherein detecting a touch at a predefined calibration point comprises detecting selection of an projected button on the surface of the location sensing electronic whiteboard.

9. A system for calibrating positions between the surface of a location sensing electronic device and a display device coupled to an electronic device, comprising:
a location sensing electronic device comprising a location sensing surface and an exterior frame;
an electronic device comprising a display device, and coupled to a projection device and the location sensing electronic device;
a projection device coupled to the electronic device comprising means for projecting an image on the location sensing electronic device;
wherein a predefined location on the location sensing device is programmed to calibrate positions between the surface of a location sensing electronic device and the display of an electronic device.

10. The system of claim 9, wherein the predefined location is a projected button on the surface of the location sensing device.

11. The system of claim 9, wherein the predefined location is an actual button on the surface of the location sensing device.

12. The system of claim 9, wherein the predefined location is an actual button on the exterior frame of the location sensing device.

13. A system for calibrating positions between the surface of an electronic whiteboard and the monitor of a personal computer, comprising:
an electronic whiteboard comprising a touch sensitive surface and an exterior frame;
a personal computer coupled to a projection device, a monitor, and the electronic whiteboard; and
a projection device coupled to the personal computer comprising means for projecting an image on the electronic whiteboard;
wherein a predefined location on the electronic device is programmed to calibrate positions between the surface of the electronic whiteboard and the monitor coupled to the personal computer.

14. The system of claim 13, wherein the predefined location is a projected button on the surface of the electronic whiteboard.

15. The system of claim 13, wherein the predefined location is an actual button on the surface of the electronic whiteboard.

16. The system of claim 13, wherein the predefined location is an actual button on the exterior frame of the electronic whiteboard.
